(19) United States
(12) Patent Application Publication
(10) Pub. No.: US 2006/0017878 A1
(43) Pub. Date: Jan. 26, 2006

(54) Method for repairing white spots in liquid crystal display panel

(76) Inventor: Min-Chih Hsuan, Hsinchu (TW)

Correspondence Address: J C PATENTS, INC., 4 VENTURE, SUITE 250, IRVINE, CA, 92618, US

(21) Appl. No.: 11/206,446

(22) Filed: Aug. 17, 2005

Related U.S. Application Data
(62) Division of application No. 10/704,396, filed on Nov. 6, 2003.

(51) Int. Cl. G02F 1/13

(52) U.S. Cl. 349/192

(57) ABSTRACT

A method of repairing white spots on a liquid crystal display (LCD) panel and a LCD pane thereof are provided. The method includes the steps of detecting any white spot on the liquid crystal display after the manufacturing process and repairing the white spot by coating a repairing spot on the surface of the panel above the white spot. Furthermore, the repairing spot may have a micro-lens structure. Therefore, the repairing spot can absorb, diverge or scatter the light from the white spot. Alternatively, the repairing spot can also change the optical pathway or the polarity or the polarity distribution of the light from the white spot so that an analyzer or a polarizer can block the light from the white spot to produce a dark spot.

### BACKGROUND OF THE INVENTION

1. Field of the Invention

The present invention relates to a method of repairing defective spots on a liquid crystal display panel. More particularly, the present invention relates to a method of using micro-lens technique to repair white spots in a liquid crystal display panel.

2. Description of the Related Art

In recent years, there are a number of breakthroughs in the manufacturing of display devices such as computer monitors and televisions. In compared with a cathode ray tube (CRT), a liquid crystal display (LCD) has gradually become one of the mainstream display products in the market since the advantages of low operating voltage, low power consumption, no radiation, light weight, thin thickness and compact package.

However, due to a variety of technological limitations, the screen size of a liquid crystal display devices is limited to be below 30 inches. For a larger size display panel such as a screen size between 30 to 60 inches, the plasma display panel (PDP) is a potential candidate. However, the high cost of the production the plasma panel display renders other types of display devices such as a projection display device to be more economical and feasible. A variety of reflective projection display devices, for example, such as liquid crystal display (LCD), digital light projector (DLP) and liquid crystal on silicon (LCOS), has been developed in order to reduce the cost of production of a large size display. Although the LCD and DLP devices are still the dominant devices of the displays in the mean while, the liquid crystal on silicon (LCOS) has great potential for future development. In general, the LCOS display has a low cost of production, a high opening rate (up to 90%) and a high resolution (a pixel pitch down to 12 μm). With these advantages, a lot of display device manufacturers are actively engaged in the development of related technologies to prevail in the micro-display market.

As to both of the liquid crystal display (LCD) device and the liquid crystal on silicon (LCOS) display device, a liquid crystal display panel is required. In the manufacturing process of a liquid crystal display panel, a major factor affecting the yield of the display quality is the generation of defect spots. The so-called defect spots are the constant bright or constant dark spots on a liquid crystal display panel that can not be control and can no longer be repaired. The defect spots are typically generated in the manufacturing process of the liquid crystal display panel by various factors such as one or more particles failed on the panel, a damage caused by the electrostatic charge or the improper control of the process parameters. In general, the defect spots can be classified into white spots or dark spots. The white spots are any pixel points that show up bright no matter which type of pictures is displayed by the display screen. The white spots are revealed when the display of frame is switched to a black frame. On the other hand, the dark spots are pixel points that show up dark no matter which type of pictures is displayed by the display screen. The dark spots are revealed when the display of frame is switched to a white frame. Because the white spots are more abhorrent to user than the dark spots, the prevention of generation of the white spots during the manufacturing process is required.

### SUMMARY OF THE INVENTION

Accordingly, at least one object of the present invention is to provide a method of converting the white spots on a manufactured liquid crystal display into dark spots.

To achieve these and other advantages and in accordance with the purpose of the invention, as embodied and broadly described herein, the invention provides a method for repairing white spots on a liquid crystal display panel and a white spot free liquid crystal display panel device. To repair the white spot on a liquid crystal display panel, a repairing spot is formed over the white spot. The repairing spot has important interference properties for absorbing, diverting or scattering the light from the white spot. Alternatively, the repairing spot may have important properties for changing the optical path and the polarity or the polarity distribution of the light from the white spot so that the light from the white spot can be blocked by an analyzera or a polarizer to convert the white spot into a dark spot.

In one embodiment of this invention, a method for repairing the white spots on a liquid crystal display panel is provided. The method includes detecting the presence of any white spots on a liquid crystal display panel. When a white spot is detected, a repairing spot is coated on the surface of the liquid crystal display panel above the white spot to convert the white spot into a dark spot.

In the method of repairing white spots on a liquid crystal display panel according to one embodiment of this invention, a material of the repairing spots for repairing white spots on a liquid crystal display panel includes an organic material.

In the method of repairing white spots on a liquid crystal display panel according to one embodiment of this invention, the method of converting a white spot into a dark spot includes a method of absorbing, diverging or scattering the light traveling through the white spot. In a preferred embodiment, a structure of the repairing spot includes a micro-lens structure.

In the method of repairing white spots on a liquid crystal display panel according to one embodiment of this invention, the method of converting a white spot into a dark spot includes a method of changing the optical path of the light traveling from the white spot through a repairing spot. After changing the optical path of the incoming light, an analyzer can convert the white spot into a dark spot. In a preferred embodiment, a structure of the repairing spot includes a micro-lens structure.

In the method of repairing white spots on a liquid crystal display panel according to one embodiment of this invention, the method of converting a white spot into a dark spot includes a method of changing the polarity or the polarity distribution of the light traveling from the white spot through a repairing spot. After changing the polarity or the polarity distribution of the light, a polarizer can convert the white spot into a dark spot. In a preferred embodiment, a structure of the repairing spot includes a micro-lens structure.

In the method of repairing white spots on a liquid crystal display panel according to one embodiment of this invention, the method of converting a white spot into a dark spot includes a method of absorbing, diverging or scattering the light reflected from the white spot. In a preferred embodiment, a structure of the repairing spot includes a micro-lens structure.

In the method of repairing white spots on a liquid crystal display panel according to one embodiment of this invention, the method of converting a white spot into a dark spot includes a method of changing the optical path of the light reflected from the white spot through a repairing spot. After changing the optical path of the reflected light, an analyzer can convert the white spot into a dark spot. In a preferred embodiment, a structure of the repairing spot includes a micro-lens structure.

In the method of repairing white spots on a liquid crystal display panel according to one embodiment of this invention, the method of converting a white spot into a dark spot includes a method of changing the polarity or the polarity distribution of the light reflected from the white spot through a repairing spot. After changing the polarity or the polarity distribution of the light, a polarizer can convert the white spot into a dark spot. In a preferred embodiment, a structure of the repairing spot includes a micro-lens structure.

This invention also provides a white spot free liquid crystal display panel. The method of removing the white spots on a liquid crystal display panel includes coating a repairing spot on the liquid crystal display panel above each white spot.

In the white spot free liquid crystal display panel according to one embodiment of this invention, a material of the repairing spots for repairing white spots on a liquid crystal display panel includes an organic material.

In the white spot free liquid crystal display panel according to one embodiment of this invention, the method of converting a white spot into a dark spot includes a method of absorbing, diverging or scattering the light traveling through the white spot through a repairing spot. In a preferred embodiment, a structure of the repairing spot includes a micro-lens structure.

In the white spot free liquid crystal display panel according to one embodiment of this invention, the method of converting a white spot into a dark spot includes a method of changing the optical path of the light traveling from the white spot through a repairing spot. After changing the optical path of the incoming light, an analyzer can convert the white spot into a dark spot. In a preferred embodiment, a structure of the repairing spot includes a micro-lens structure.

In the white spot free liquid crystal display panel according to one embodiment of this invention, the method of converting a white spot into a dark spot includes a method of changing the polarity or the polarity distribution of the light traveling through the white spot through a repairing spot. After changing the polarity or the polarity distribution of light, a polarizer can convert the white spot into a dark spot. In a preferred embodiment, a structure of the repairing spot has a micro-lens structure.

In the white spot free liquid crystal display panel according to one embodiment of this invention, the method of converting a white spot into a dark spot includes a method of absorbing, diverging or scattering the light reflected from the white spot through a repairing spot. In a preferred embodiment, a structure of the repairing spot includes a micro-lens structure.

In the white spot free liquid crystal display panel according to one embodiment of this invention, the method of converting a white spot into a dark spot includes a method of changing the optical path of the light reflected from the white spot through a repairing spot. After changing the optical path of the reflected light, an analyzer can convert the white spot into a dark spot. In this embodiment, the repairing spot has a micro-lens structure.

In the white spot free liquid crystal display panel according to one embodiment of this invention, the method of converting a white spot into a dark spot includes changing the polarity or the polarity distribution of the light reflected from the white spot through a repairing spot. After changing the polarity or the polarity distribution of light, a polarizer can convert the white spot into a dark spot. In a preferred embodiment, a structure of the repairing spot includes a micro-lens structure.

Accordingly, this invention provides a method of repairing white spots on a liquid crystal display (LCD) panel and a white spot free LCD panel using thereof. The method includes the steps of detecting any irreparable white spots on the liquid crystal display panel and then coating a repairing spot on the surface of the liquid crystal display panel above each white spot so that the white spots are converted into dark spots.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating the structure of a normal liquid crystal display panel.

FIG. 2 is a schematic cross-sectional view of a liquid crystal display panel with a white spot and a repairing structure according to one embodiment of this invention.

FIG. 3 is a schematic cross-sectional view illustrating the structure of a normal liquid crystal on silicon display panel.

FIG. 4 is a schematic cross-sectional view of a liquid crystal on silicon display panel with a white spot and a repairing structure according to one embodiment of this invention.

FIGS. 5A and 5B are transparent diagrams illustrating two micro-lens structures according to one embodiment of this invention.

### DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

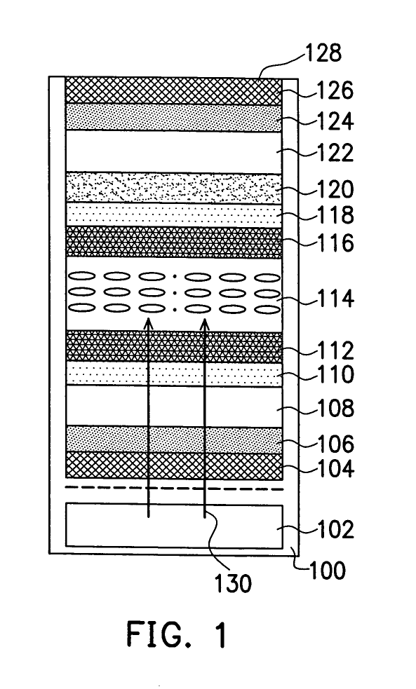

FIG. 1 is a schematic cross-sectional view illustrating the structure of a normal liquid crystal display panel. Referring to FIG. 1, a liquid crystal display panel 100 is provided. The liquid crystal display panel 100 includes a back light module 102, a first polarizer 104, a first compensation film 106, a first glass 108, a first transparent conductive layer 110 (e.g., an indium tin oxide (ITO) layer), a first poliemid layer 112, a liquid crystal layer 114, a second poliemid layer 116, a second transparent conductive layer 118 (e.g., an indium tin oxide (ITO) layer), a color filter 120, a second glass 122, a second compensation film 124, a second polarizer 126 and a top surface 128. In a normal liquid crystal display panel 100, the liquid crystal layer 114 is free from dust, particle or scratch marks. In the normal operation of the liquid crystal display panel 100, a beam of light 130 is emitted from the back light module 102. If the liquid crystal layer 114 is set to an opaque operating mode, the light 130 from the back light module 102 is totally blocked by the liquid crystal layer 114. Hence, the screen of the display panel is black as shown in FIG. 1.

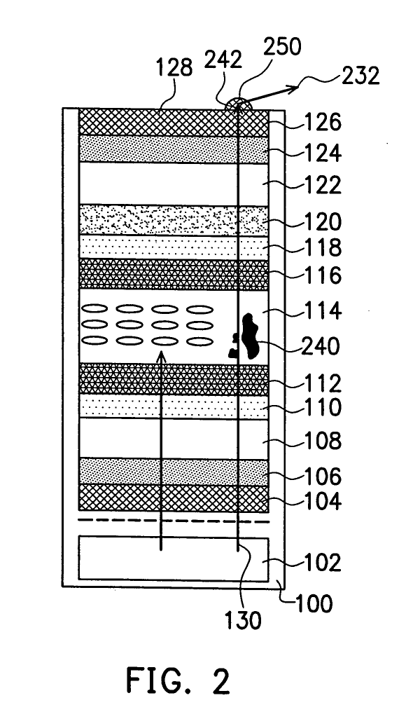

FIG. 2 is a schematic cross-sectional view of a liquid crystal display panel with a white spot and a repairing structure according to one embodiment of this invention. As shown in FIG. 2, for example, dust particles, scratch marks or impurities 240 may be disposed in the liquid crystal layer 114 during the manufacturing process. Therefore, an irreparable damage in a portion of the liquid crystal layer 114 is generated when the panel 100 is completed. When the liquid crystal layer 114 is set to an opaque operating mode, most of the light 130 from the back light module 102 is blocked. However, a portion of the light 130 may leak to the top surface 128 through the damaged region wherein the impurities 240 are located because the region only has very few liquid crystal molecules to block the light 130. Hence, a white spot 242 is generated on the top surface 128.

Accordingly, the invention provides a method of repairing the white spots on a liquid crystal display panel. After an irreparable white spot on the liquid crystal display panel is detected, a repairing spot 250 is formed on the panel above the white spot 242. The repairing spot 250 is manufactured from an organic material having the properties that can interfere with the light 130 traveling through the white spot. In one embodiment, for example, the light 130 traveling to the white spot 242 can be absorbed by the repairing spot 250. In another embodiment, the light 130 traveling to the white spot 242 can be refracted. In yet another embodiment, the light 130 traveling to the white spot 242 can be scattered to various directions. Furthermore, to increase the scattering efficiency and the uniformity of scattering of the light 130, the structure of the repairing spot 250 includes a micro-lens structure.

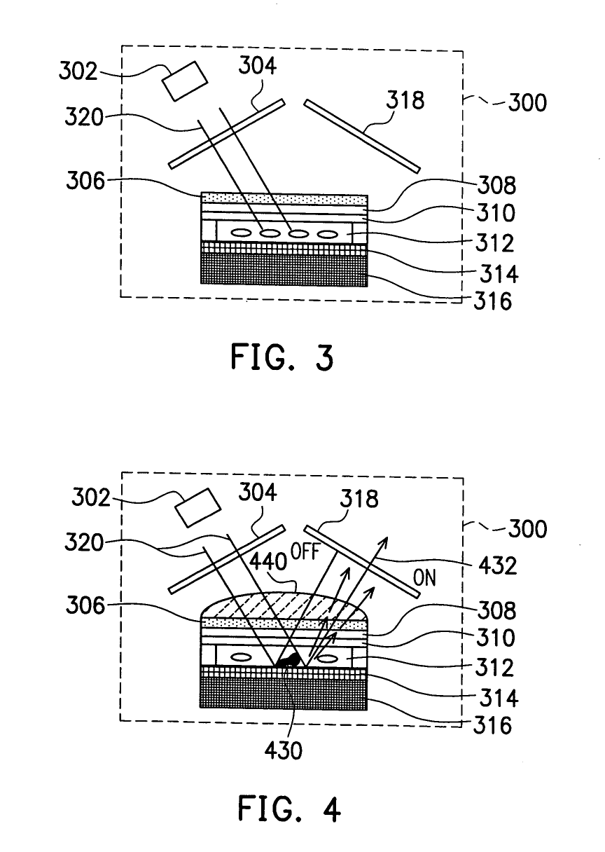

FIG. 3 is a schematic cross-sectional view illustrating the structure of a normal liquid crystal on silicon display panel. As shown in FIG. 3, a liquid crystal on silicon (LCOS) display panel 300 is provided. The LCOS display panel 300 includes a light source 302, a polarizer 304, a cover glass 306, a first transparent conductive layer 308 (e.g., an indium-tin-oxide (ITO) layer), an alignment layer 310, a liquid crystal layer 312, a high-reflectance metallic layer 314, a complementary metal-oxide-semiconductor (CMOS) substrate 316 and an analyzer 318. In a normal LCOS display panel 300, the liquid crystal layer 312 is free from any dust, particle or scratch mark. In the normal operation of the LCOS display panel 300, a beam of light 320 is emitted from the light source 302. If the liquid crystal layer 312 is set to an opaque operating mode, the light 320 from the light source 302 is totally blocked by the liquid crystal molecules in the liquid crystal layer 312 and hence will not reach the high-reflectance metallic layer 314. Hence, the light 302 no longer travels to the analyzer 318 to form an image and the screen of the display panel is black as shown in FIG. 3.

FIG. 4 is a schematic cross-sectional view of a liquid crystal on silicon display panel with a white spot and a repairing structure according to one embodiment of this invention. As shown in FIG. 4, dusts, particles, scratch marks or impurities 240 is disposed in the liquid crystal layer 312 during the manufacturing process. Therefore, an irreparable damage in a portion of the liquid crystal layer 312 is formed when the panel 300 is completed. When the liquid crystal layer 312 is set to an opaque operating mode, most of the light 320 from the light source 302 is blocked. However, a portion of the light 320 may leak to the analyzer 318 via the damaged region wherein the impurities 430 are located to the cover glass 306 because the damaged region contains very few liquid crystal molecules. Hence, a white spot 432 is generated on the analyzer 318.

Therefore, the invention provides a method of repairing white spots on a liquid crystal on silicon (LCOS) display panel. After an irreparable white spot 432 on the LCOS display panel is detected, a repairing spot 440 is formed on the cover glass 306 of the LCOS display panel 300 above the white spot 432. The repairing spot 440 is manufactured from an organic material having the properties that can absorb, refract or scatter the light 320, or can change the polarity or the polarity distribution of the light 320. Furthermore, to increase the scattering efficiency and the uniformity of scattering of the light 320, the structure of the repairing spot 440 includes a micro-lens structure.

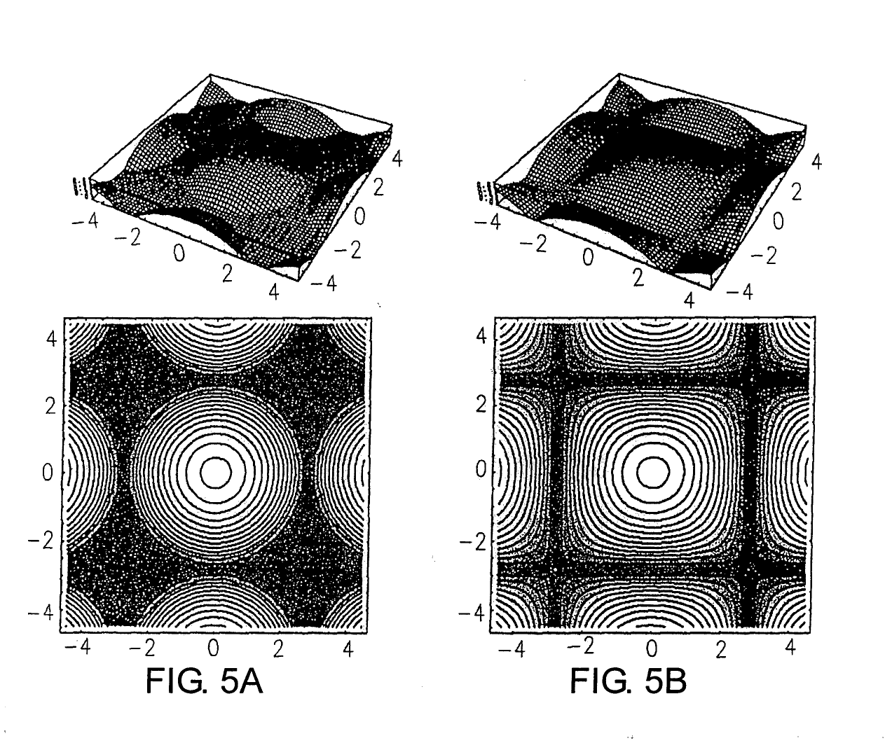

FIGS. 5A and 5B are transparent diagrams illustrating two micro-lens structures according to one embodiment of this invention. An inscribed ellipsoidal type of micro-lens structure is shown in FIG. 5A and a square cushion type of micro-lens structure is shown in FIG. 5B. The micro-lens is manufactured by using an organic material. In general, the micro-lens has at least two major functions. First, the micro-lens can absorb, diverge or scatter the light from a white spot as in a liquid crystal display panel in FIG. 2 and a liquid crystal on silicon (LCOS) display panel in FIG. 4. In addition, the micro-lens is also capable of changing the optical path or the polarity or the polarity distribution of light coming from a white spot so that a polarizer or an analyzer can block the light. These functions can be utilized to convert the white spot on the liquid crystal in FIG. 2 or the white spot on the liquid crystal on silicon display panel in FIG. 4 into a black spot.

Accordingly, the invention provides a method of repairing the white spots on a liquid crystal display panel and a white spot free LCD panel using thereof. A repairing spot is formed on the surface of the liquid crystal display panel above each white spot. Furthermore, the structure of the repairing spot can includes a micro-lens structure. The repairing spot can absorb, diverge or scatter the light from the white spot. Alternatively, the repairing spot can also change the optical path or the polarity or the polarity distribution of the light from the white spot so that a polarizer or an analyzer can block the light. Hence, the white spot is converted into a dark spot.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A repairing method of repairing a white spot on a liquid crystal display panel, comprising:
detecting a white spot on a liquid crystal display panel, when a white spot is detected; and
coating a repairing spot on the liquid crystal display panel above the white spot, wherein the white spot is converted into a dark spot by the repairing spot;
wherein a structure of the repairing spot comprises a micro-lens structure for converting the white spot into the dark spot.

2-10. (canceled)

11. The repairing method of claim 1, wherein the micro-lens converts the white spot into the dark spot by absorbing a light from the white spot.

12. The repairing method of claim 1, wherein the micro-lens converts the white spot into the dark spot by refracting a light from the white spot.

13. The repairing method of claim 1, wherein the micro-lens converts the white spot into the dark spot by scattering a light from the white spot.

14. The repairing method of claim 1, wherein the micro-lens changes an optical path of a light from the white spot.

15. The repairing method of claim 14, wherein an analyzer converts the white spot into the dark spot after the optical path is changed through the micro-lens.

16. The repairing method of claim 1, wherein the micro-lens changes a polarity or a polarity distribution of a light from the white spot.

17. The repairing method of claim 16, wherein a polarizer converts the white spot into the dark spot after the polarity or the polarity distribution of the light is changed through the micro-lens.

18-25. (canceled)

26. The repairing method of claim 1, wherein the micro-lens converts the white spot into the dark spot by absorbing a light reflected from the white spot.

27. The repairing method of claim 1, wherein the micro-lens converts the white spot into the dark spot by refracting a light reflected from the white spot.

28. The repairing method of claim 1, wherein the micro-lens converts the white spot into the dark spot by scattering a light reflected from the white spot.

29. The repairing method of claim 1, wherein micro-lens changes an optical path of a light reflected from the white spot.

30. The repairing method of claim 29, wherein an analyzer converts the white spot into the dark spot after the optical path of the reflected light is changed through the micro-lens.

31. The repairing method of claim 1, wherein the micro-lens changes a polarity or a polarity distribution of a light reflected from the white spot.

32. The repairing method of claim 31, wherein a polarizer converts the white spot into the dark spot after the polarity or the polarity distribution of the reflected light is changed through the micro-lens.

33. A liquid crystal display panel with a white spot thereon that can be converted to a dark spot by coating a repairing spot on a surface of the liquid crystal display panel above the white spot;
wherein the repairing spot has a micro-lens structure for converting the white spot into the dark spot.

34-42. (canceled)

43. The liquid crystal display panel of claim 33, wherein the micro-lens converts the white spot into the dark spot by absorbing a light from the white spot.

44. The liquid crystal display panel of claim 33, wherein the micro-lens converts the white spot into the dark spot by refracting a light from the white spot.

45. The liquid crystal display panel of claim 33, wherein the micro-lens converts the white spot into the dark spot by scattering a light from the white spot.

46. The liquid crystal display panel of claim 33, wherein micro-lens changes an optical path of a light from the white spot.

47. The liquid crystal display panel of claim 46, wherein an analyzer converts the white spot into the dark spot after the optical path is changed through the micro-lens.

48. The liquid crystal display panel of claim 33, wherein the micro-lens changes a polarity or a polarity distribution of light from the white spot.

49. The liquid crystal display panel of claim 48, wherein a polarizer converts the white spot into the dark spot after the polarity or the polarity distribution of the light is changed through the micro-lens.

50-57. (canceled)

58. The liquid crystal display panel of claim 33, wherein the micro-lens converts the white spot into the dark spot by absorbing a light reflected from the white spot.

59. The liquid crystal display panel of claim 33, wherein the micro-lens converts the white spot into the dark spot by refracting a light reflected from the white spot.

60. The liquid crystal display panel of claim 33, wherein the micro-lens converts the white spot into the dark spot by scattering a light reflected from the white spot.

61. The liquid crystal display panel of claim 33, wherein the micro-lens changes an optical path of a light reflected from the white spot.

62. The liquid crystal display panel of claim 61, wherein an analyzer converts the white spot into the dark spot after the optical path of the reflected light is changed through the micro-lens.

63. The liquid crystal display panel of claim 33, wherein the micro-lens changes a polarity or a polarity distribution of light reflected from the white spot.

64. The liquid crystal display panel of claim 63, wherein a polarizer converts the white spot into the dark spot after the polarity or the polarity distribution of the reflected light is changed through the micro-lens.
